(19) United States
(12) Patent Application Publication
(10) Pub. No.: US 2016/0064104 A1
(43) Pub. Date: Mar. 3, 2016

(54) Relativistic Vacuum Diode for Shock Compression of a Substance

(71) Applicant: Proton Scientific, Inc., Urbana, IL (US)

(72) Inventor: Stanislav Vasilyevich Adamenko, Kiev (UA)

(21) Appl. No.: 14/839,298

(22) Filed: Aug. 28, 2015

(30) Foreign Application Priority Data
Sep. 2, 2014 (UA) A 2014 09639

(51) Int. Cl. G21B 1/03

(52) U.S. Cl. CPC G21B 1/03

(57) ABSTRACT

A relativistic vacuum diode (RVD) for shock compression of a substance to a superdense state is provided. The RVD may include an axisymmetric current-conducting vacuum chamber equipped with a demountable hatch for access into its cavity; an axisymmetric electrode assembly fixed in operative position in the central zone of the vacuum chamber; it has a plasma cathode composed of a thin central current-conducting rod and wide dielectric end element, and anode-enhancer shaped as a rod, one butt-end of which is spheroidal and serves as a target for an electron beam, at that the target cross-section area is smaller as the emitting area of said cathode's wide dielectric end element; and a such short-circuiter of reverse current in an earthed circuit of the anode-enhancer that surrounds concentrically with radial clearance said electrode assembly.

### TECHNICAL FIELD

The present disclosure relates to a structure of relativistic vacuum diodes (hereinafter RVDs) meant for the study of processes of shock compression of a solid substance to a superdense state in which pycnonuclear processes may proceed.

### CROSS-REFERENCE TO RELATED APPLICATION

This non-provisional U.S. patent application claims the benefit of priority from Ukrainian Patent Application No. a 2014 09639 filed on Sep. 2, 2014.

### BACKGROUND

The potential to transform nuclei of chemical elements under action of electrons and high pressure and problems with their stability were theoretically considered by physicist, Ya. B. Zel'dovich (see Journal of Experimental and Theoretical Physics, V.33, p. 991, 1957), and thereafter by, A. G. Cameron (see Astrophysical Journal, V.130, p. 916, 1959). However, neither of the above-mentioned considerations, nor many other similar publications, give specified recommendations concerning methods and means suitable for experimental study in this area.

K. F. Zelenskii, O. P. Pecherskii, and V. A. Tsukerman described the first experiments for shock compression of a substance by electron beams in the article “Effects of electron impact on the anode of pulsed X-Ray tube” (see Journal of Technical Physics, 1968, p. 1581-1587 republished in USA in 1969). The pulsed X-ray tube used as the base for the experimental equipment in the study of shock compression of a substance had a hollow thin-walled all-metal cathode in the form of a truncated cone having a pointed edge and sets of replaceable conductive all-metal target anodes made from aluminum, copper and steel in the form of cylinders having different diameters and lengths, or in the form of spheres having a uniform diameter of 1 cm.

In the operative position, the cathode was directed at a selected anode supported by a small base. The anode was located relative to the cathode concentrically with wide a circular gap and was usually remote from the cathode pointed edge at an adjustable distance <<L>> as shown in FIG. 1 of the article. During some experiments, a spherical anode was located at the level of the cathode pointed edge in such manner that it was surrounded, but not too tightly embraced, by the cathode. During experiments, current pulses in the range of 10 to 20 kA and widths of no more than 400 ns for cylindrical anodes and no more than 550 ns for spherical anodes (see, respectively, tables 1 and 2 in the article) were used.

The simplest calculations revealed that the impact onto spherical anodes by maximal current pulses 20 kA ensures average current density of about 6.37*10³ A/cm² on the surface of a sphere having a diameter of 1 cm. Based on the results of many experiments, it was determined that rather long-term (from 400 to 550 ns) shock action of electron beam onto gross (about 1 cm in diameter) all-metal target anodes causes (a) impetuous heating and vaporization of metal surface layers of cylindrical and spherical anodes, and (b) centripetal impact ablative compression of the rest of the material of these anodes and, as a result, substantial alterations. Notably, the alterations included deformation of the aluminic spherical anodes or appearance of spherical cavities having diameters of about 5 mm within aluminic and copper anodes, which were evidently perceivable by the naked eye (see respectively FIGS. 5b and 5c of the article), and alterations in color tones within some steel anodes because of partial microstructure modifications (see FIG. 6 of the article).

The foregoing showed that pressure generated by ablative compression near the centers of the spherical target anodes can reach up to 130 kilobar (i.e. 13000 MPa). However, these results had been long forgotten, and the problem of creating more effective methods and means for shock compression of a substance into a superdense state using electron beams had been left unresolved despite the availability of well-known relativistic vacuum diodes (see, for example: 1. C. D. Child, Phys. Rev., V.32, p. 492, 1911; 2. I. Langmuir, Phys. Rev., V.2, p. 450, 1913).

Each RVD has a vacuum chamber with a cathode and an anode fixed in this chamber and connected with an electric charge integrator by means of a surge gap. With a sufficiently great charge and a short duration of a discharge pulse, such diodes are capable of providing an explosive electron emission from the cathode's surface and acceleration of electrons to relativistic velocity with efficiencies of more than 90%. For the purposes of generators and accelerators of powerful electron beams, RVDs had been the object of attention of physicists during the entire 20th century. Unfortunately, many improvements of these RVDs were aimed only at spatio-temporal energy compressions in electron beams and spatial shaping of these beams (see, for example: 1. SU 1545826; 2. A. V. Gunin, V. F. Landl, S. D. Korovin, G. A. Mesyats and V. V. Rostov “Long-lived explosive-emission cathode for high-power microwave radiation generators”//Technical Physics Letters”, V.25 (11), 1999, pp. 922-926 and many other).

Adaptability of a RVD for shock compression of a substance to a superdense state under action of electron beams was for the first time disclosed at International Conference dedicated to particle accelerators (S. Adamenko, E. Bulyak et al. Effect of Auto-focusing of the Electron Beam in the Relativistic Vacuum Diode. (In: Proceedings of the 1999 Particle Accelerator Conference, New York, 1999)), and in the article “Creating and using of superdense micro-beams of relativistic electrons. Nuclear Instruments and Methods” of V. I. Vysotski, S. V. Adamenko et al. (see Physics Research, A 455, 2000, p. 123-127).

A method of shock compression of a substance, which can be easily perceived by those skilled in the art based on the two sources mentioned above includes producing a needle-like anode-enhancer, a rounded spike of which serves as a target, placing the said anode-enhancer in the vacuum chamber of the RVD opposite the plasma cathode and on the same geometric axis with a few millimeters gap, and providing a pulse discharge of the power source via the RVD in the self-focusing mode of an electron beam on the surface of the target. The RVD for shock compression of a substance by this method comprises a vacuum chamber that has a housing made from a current-conducting material, a removable cover and a means for connection to a vacuum pump, and fixed in the chamber practically on the same geometric axis an axisymmetric plasma cathode connected, in operative position, to a pulsed high-voltage generator (hereinafter PHVG), and an axisymmetric anode-enhancer earthed, in operative position, immediately via all current-conducting housing of the vacuum chamber.

The plasma cathode has a current-conducting rod converging in the direction of the anode-enhancer and the dielectric end element, where the perimeter and the operative butt-end area of this dielectric end element are no greater than the respective perimeter and the cross-sectional area of the rod. Shaping of the electrodes in such specific geometric forms allows suppression of the pinch in the RVD gap and sharpening of the electron beam for its self-focusing on a small portion of the anode-enhancer surface. However, the essentially point action on the needle-like anode-enhancer is suitable only for demonstration of applicability of the RVD for shock compression of a substance, and it cannot provide the compression of a substantial portion of the target body to a superdense state at each pulse discharge.

A next improvement of a RVD meant for shock compression of a condensed (i.e. solid or capsulated liquid) substance to a superdense state was described in the International Application PCT/UA03/00015 (priority date Aug. 14, 2002), and in patents UA 71084; RU 2261494; EP 1464210; AU 2003232876; CN ZL03803607.X, JP 4708022, IN 246394 etc. granted on basis of said International Application. These documents disclose three general concepts. Firstly, a method is disclosed for shock compression of a condensed (preferably solid) substance of a spheroidal target by converging toward the spheroid center soliton-like energy impulse of the electron beam. Secondly, a RVD is disclosed for the realization of this method, the subject matter of which is nearest to the subject matter of the proposed below improved RVD. Thirdly, a compound plasma cathode of the RVD is disclosed.

The RVD according to the said PCT/UA 03/00015 comprises an axisymmetric vacuum chamber, which has a current-conducting housing that is equipped with a located on one its butt-end removable dielectric cover meant for access into said chamber for replacement of consumable details, and at least one opening for connection of said chamber to a vacuum pump, as necessary. The RVD also comprises an axisymmetric plasma cathode and an axisymmetric anode-enhancer mounted with an adjustable gap in the said vacuum chamber practically on the same geometric axis, where the distance from this geometric axis to the inner side of said current-conducting housing is greater than 50 dₘₐₓ, where dₘₐₓ is a maximum cross-sectional dimension of the anode-enhancer.

The plasma cathode is fixed within the housing and composed of a current-conducting rod connected, in operative position, to a PHVG, and an emitter of electrons in the form of a dielectric end element provided onto said rod, the emitting area of which is more than the maximum cross-sectional area of the anode-enhancer. The anode-enhancer is shaped as round in the cross-section current-conducting rod, which has a spheroidal operative butt-end that serves as a target in the operative position and which earthed immediately via all said current-conducting housing of the vacuum chamber and further via a housing of a PHVG that connected with the RVD in operative position. Optionally, the anode-enhancer tail part can be equipped with a replaceable disposable polished shield, which is entirely made from a current-conducting material and is a catcher of products of transmutation of the target substance.

During preparation of the RVD to regular discharge of mentioned PHVG, the anode-enhancer has placed opposite the plasma cathode emitting area with such experimentally selected gap, at which the center of curvature of its spheroidal operative butt-end was located within focal space of a collectively self-focusing electron beam. Such RVD together with the PHVG ensures super-short (no more than 100, but preferably less than 50 ns) current pulses that able to generate beams of high-energy (no less than 0.2, but preferably up to 0.5 MeV) electrons for shock compression of spheroidal targets at current density on their surface in the range from 10⁶ to 10⁸ A/cm².

Even energy consumption during one discharge via the RVD was about 100 J, where these operating parameters were sufficient for the initiation of pycnonuclear process in targets comprising of the most stable atoms of different chemical elements (especially copper, tantalum and lead), and the production in each experiment of 10¹⁷-10¹⁸ atoms of other chemical elements owing to transmutation of the target substance. Many experiments using the known RVD according to the PCT/UA03/00015 allowed discovering an unknown in nuclear physics phenomenon that collapses into physical point of a spheroidal dose of selected condensed substance under action of converging to the spheroid center soliton-like energy impulse, and to demonstrate that such collapse ensures the following.

Firstly, overcoming the Coulomb repulsion between atoms' electron shells and transition of an used substance into such state that may be specified as <<electron-nuclear plasma>>. Secondly, recombination of electrons and nucleons into atoms of stable non-radioactive or metastable isotopes of such chemical elements, which were absent in an initial target substance and, partly, are unknown in contemporary science no-recognized to this day transuranides with atomic weights more than 600 amu. Thirdly, explosion and flying-off corpuscular products of recombination of electron-nuclear plasma. Fourthly, energy generation including kinetic energy of said flying corpuscular products and electromagnetic radiation in spread-spectrum of wavelengths (up to Roentgen and gamma rays).

All patent specifications based on the PCT/UA03/00015 include the Table 1, where data concerning permissible dimensions of dielectric end elements of plasma cathode, operative butt-ends of the anode-enhancer and interelectrode gaps are given. Keeping these dimensions ensures practically hit of a center of curvature of each spheroidal target into the focal space of the collectively self-focusing electron beam and, accordingly, transmutation of a significant part of an used target substance at each pulse discharge. However, earthing the anode-enhancer directly via all said current-conducting housing of the vacuum chamber lengthens route of reverse current and have a bad influence on inductance of experimental system in whole. Correspondingly, duration of pulse discharge of the PHVG via the interelectrode gap of the RVD and energy consumption for shock compression of a substance to superdense state increase.

### SUMMARY OF THE DISCLOSURE

This present disclosure bases on the problem—by improvement of outline of reverse current within the vacuum chamber—to create such RVD for shock compression of a substance to a superdense state, in which length of reverse current route in the earth circuit of an anode-enhancer would be shortcut and, respectively, a bad influence of inductance of a vacuum chamber on inductance of experimental system in whole would be substantially decreased.

This problem has solved in that a RVD for shock compression of a solid substance to a superdense state comprises (1) an axisymmetric vacuum chamber; this chamber is made from a current-conducting material and confined by a cylindrical shell ring that is equipped with one butt flange, a removable cover that fixed onto said flange and equipped in proper midportion with a demountable hatch for access into the said chamber cavity, and a partition that has at least one through-hole and separates, in operative position, said cavity from a located next buffer cavity communicating with a vacuum line; (2) an axisymmetric electrode assembly that fixed in operative position in the central zone of said vacuum chamber; and (3) a short-circuiter of reverse current;

The axisymmetric electrode assembly comprises first and second parallel dielectric plates having central openings, geometrical axes both of which are coincident with symmetry axis of said vacuum chamber, at that first dielectric plate located opposite said removable cover and second dielectric plate located opposite said partition of this chamber; at least two oppositely located dielectric uprights, which rigidly couple said dielectric plates; a plasma cathode, composed of a central current-conducting rod connecting, in operative position, to a pulsed high-voltage generator and a dielectric end element that gotten coaxially onto said central rod, at that area of operative butt-end of said dielectric element exceeds cross-section area of said central rod; a clamper of the plasma cathode that fixed in said central opening of said second dielectric plate and has a termination point for connection of this cathode, in operative position, to a pulsed high-voltage generator; an anode-enhancer in the form of a rod of solid material, one butt-end of which shaped as spheroid and serves, in operative position, as a target for an electron beam, at that maximal cross-section area of this anode-enhancer is less than emitting area of said dielectric end element of the plasma cathode; and a clamper of the anode-enhancer that inserted into said central opening of said first dielectric plate and has a termination point for connection of this anode-enhancer, in operative position, to an earthed circuit;

The short-circuiter of reverse current surrounds concentrically with radial clearance said electrode assembly and has first and second flanges made from a non-ferromagnetic current-conducting material; these flanges rigidly coupled by at least three spaced with equal angular distances copper buses having identical heights and cross-sections, at that said first flange in operative position connected electrically with said anode-enhancer via its damper, and second flange connected mechanically and electrically, in operative position, with the partition of said vacuum chamber. Inclusion above-described short-circuiter into structure of the RVD allows appreciably (approximately twice) to reduce general inductance of experimental system in whole. This ensures to sharp discharge impulse front, to increase useful power in a resistive part of the RVD power circuit approximately in three times, to increase rate of a power rise in an active part of the RVD power circuit no less than in 1.3 times, and to increase efficiency of shock compression.

A first additional feature provides that the vacuum chamber is equipped with at least one viewing window. This allows observing processes and results of shock compression of a substance in experiments.

A second additional feature provides that the anode-enhancer is equipped with a catcher of transmutation products that placed next the said target. The catcher includes a mushroom body having a flat and round in plan view head and a hollow stem that clings close to a tail part of the anode-enhancer in operative position; a cylindrical hoop, which envelopes said head of the mushroom body using sliding fit and which has a circular radial flange directed at geometrical axis of this hoop, a spring washer that is closely fitted, in operative position, by its lower flat butt-end to the upper flat butt-end of said head of the mushroom body and by its side face to the inside of said cylindrical hoop, and a replaceable disposable catching shield that made from metallic foil and restrained, in operative position, between lower flat butt-end of said head of the mushroom body and said circular radial flange of said cylindrical hoop.

A third additional feature provides that said dielectric plates and said dielectric uprights of said electrode assembly made from rigid polymeric material selected from group of polycaproamide, polycarbonate and polypropylene.

A fourth additional feature provides in that said dielectric uprights of the electrode assembly have round cross-section and transversely undulating surface. This lengthens route of possible breakdown current and, thereby, decreases considerably probability of accidental disruption along side surfaces of said dielectric uprights.

A fifth additional feature provides that said dielectric end element of the plasma cathode has a central through-hole, at that its diameter is less than diameter of said central current-conducting rod of this cathode. This facilitates generation of an electron plasma shell with electron work function nearing zero nearby the operative butt-end of said dielectric end element.

A sixth additional feature provides that said flanges of the short-circuiter of reverse current made from accessible stainless steel.

### BRIEF DESCRIPTION OF THE DRAWINGS

The subject matter of the present disclosure will now be explained by detailed description of an improved RVD and use of it for shock compression of a substance to a superdense state with references to the accompanying drawings, in which:

FIG. 1 shows the RVD (longitudinal section by symmetry plane);

FIG. 2 shows an electrode assembly;

FIG. 3 shows an anode-enhancer having such catcher of transmutation products of a target substance, which is equipped with a replaceable disposable catching shield (axonometric view in an expanded scale having a partial recess); and

FIG. 4 shows a short-circuiter of reverse current in an earth circuit of the anode-enhancer (axonometric view in a slightly reduced scale).

### DETAILED DESCRIPTION

For the purpose of this description, the following terms as employed herein and in the appended claims refer to the following concepts:

“Target” is a dose to be used once for shock compression, said dose belonging, for example, to one chemical element having predetermined isotopic composition being a raw material for obtaining products of nuclear transformations and an energy source;

“Shock compression” is an isoentropic shock action of a self-focusing converging density wave of electron beam on at least a part of a target;

“Superdense state” is such state of a target after it has compressed by shock, at which a substantial portion of the target substance transforms into electron-nuclear and electron-nucleonic plasma;

“Pycnonuclear process” is such recombination interaction between components of electron-nuclear and electron-nucleonic plasma of the target substance compressed to a superdense state that causes change of the target elemental composition;

“Plasma cathode” is such axisymmetric negative electrode of the RVD that has a replaceable (if it will be worn-out) dielectric end element, which is able (in the beginning of the discharge pulse) to generate an electron plasma shell (from the near-surface layer of the dielectric end element) with electron work function nearing zero;

“anode-enhancer” is a single use axisymmetric positive electrode of the RVD that is made from solid material and has a spheroid operational butt-end being the very target; and

“Focal space” is such a portion of the RVD space, which spatially confines a certain length of the common geometric symmetry axis of the RVD electrodes and in which occurs a collective self-focusing of relativistic electrons and the electron beam embraces a target practically uniformly.

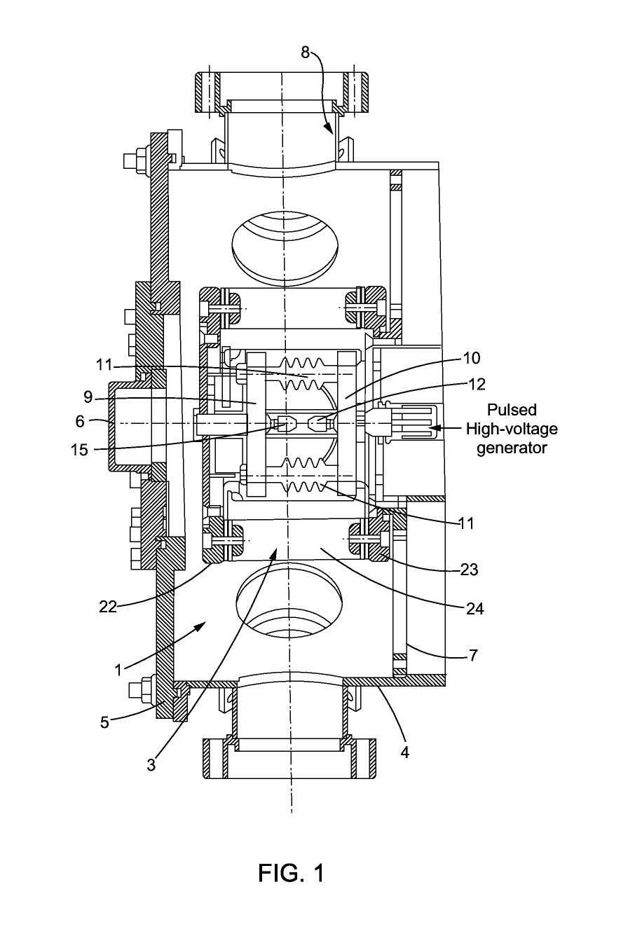

The improved RVD (see FIG. 1) has made from a current-conducting material an axisymmetric vacuum chamber 1, where an axisymmetric electrode assembly 2 and such axisymmetric short-circuiter 3 of reverse current, which envelopes said assembly 2, are concentrically mounted.

Said vacuum chamber 1 confined by

A cylindrical shell ring 4 that is equipped at its one butt by non-specified flange;

A removable cover 5 that rigidly fixed (especially, screwed) to the above-mentioned flange of said cylindrical shell ring 4 and equipped in proper midportion with a demountable hatch 6 for access into said vacuum chamber 1 for maintenance of the electrode assembly 2, and

A partition 7 that has at least one non-specified through-hole and separates, in operative position, a cavity of said vacuum chamber 1 from a located next (and also non-specified) buffer cavity communicating with a vacuum line.

Optionally, the vacuum chamber 1 can be equipped with at least one viewing window 8 (but preferably, by two or more such windows, which blocked usually by blastproof-glasses).

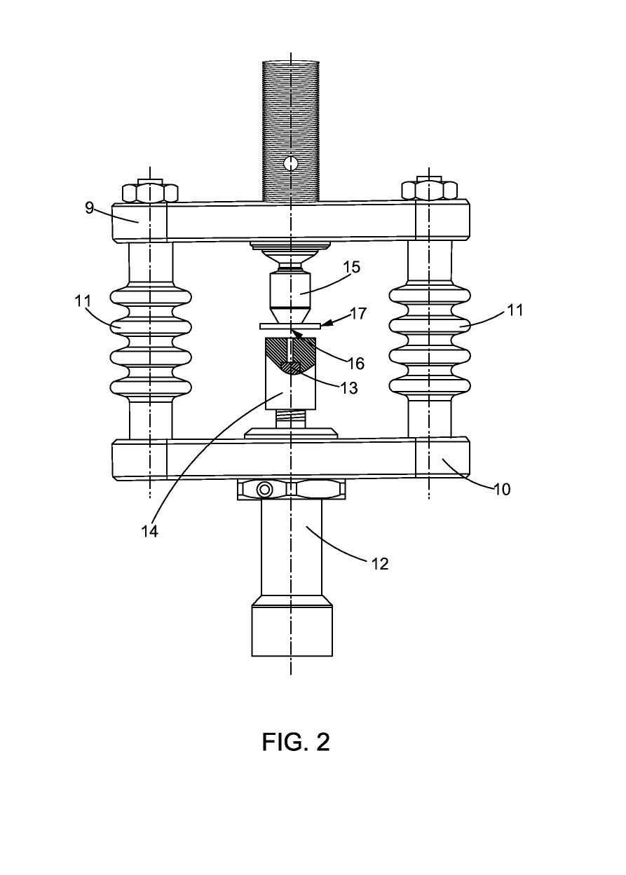

Said electrode assembly 2 has (see FIG. 2):

First (arranged opposite the cover 5) and second (arranged opposite the partition 7) parallel dielectric plates 9 and 10 having not shown and non-specified especially central openings, geometrical axes both of which are coincident with symmetry axis of the vacuum chamber 1;

Preferably two oppositely located and usually round in cross-section vertical dielectric uprights 11, which rigidly couple said dielectric plates 9 and 10 (these uprights 11 have, as a rule, transversely undulating surface for lengthening of possible breakdown current);

A clamper 12 of a described below plasma cathode (this clamper 12 is fixed in above-mentioned central opening of said second dielectric plate 10 and has a not specified termination point for connection of this cathode to a PHVG);

A plasma cathode that fixed in the clamper 12 and composed of a central current-conducting rod 13, which is connected, in operative position, to the PHVG, and a dielectric end element 14, which is coaxially gotten onto said rod 13; and

A such clamper 15 of anode-enhancer 16, that inserted (particularly, screwed) into above-mentioned central opening of said first dielectric plate 9 with possibility of adjusting reciprocal motion and has a non-specified current-conducting termination point for connection of said anode-enhancer 16 to the described in detail below short-circuiter 3 of reverse current.

Said plates 9 and 10 and said uprights 11 can make usually from such rigid polymeric materials as polycaproamide, polycarbonate, polypropylene etc.

The dielectric end element 14 of the plasma cathode can be made from a carbon-chain polymer with single carbon-carbonic bonds, e.g. from high-molecular high-density polyethylene or from polypropylene, and has usually a non-specified central through-hole, diameter of which is less than diameter of said central current-conducting rod 13.

It has manifestly showed on FIG. 2 that emitting area of operative butt-end of the dielectric end element 14 of the plasma cathode exceeds appreciably (desirably in 5-10 times) a cross-section area of the current-conducting rod 13 of said cathode and, still more appreciably, a cross-section area of said anode-enhancer 16.

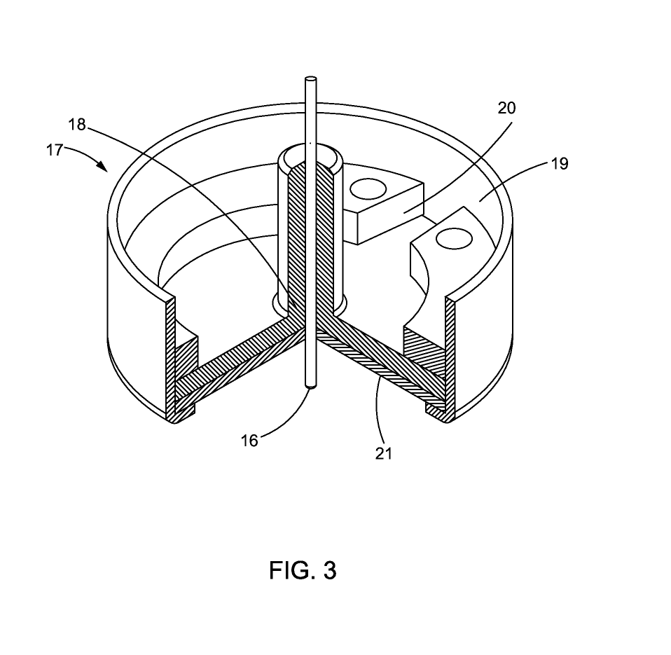

The anode-enhancer 16 (see FIG. 3) shaped as a preferably round in cross-section rod made from solid desirable (but non-obligatory) current-conducting material, including pure metals (e.g. copper, tantalum, nickel etc.), metal alloys and other solid organic and inorganic materials. An operative butt-end of the anode-enhancer 16 shaped as spheroid and serves, in operative position, as target for an electron beam, at that a maximal cross-section area of this target is substantially less than the cross-section area of said dielectric end element 14 of the plasma cathode.

As a rule, the anode-enhancer 16 is equipped with a catcher 17 of transmutation products that must be arranged next the target. This catcher 17 comprises

A mushroom body 18 having a non-specified flat and round in plan view head and an also non-specified hollow stem that clings close a tail part of the anode-enhancer 16 in operative position;

A cylindrical hoop 19, which envelopes a peripheral part of above-mentioned head of the mushroom body 18 using sliding fit and which has a circular radial flange directed at geometrical axis of this hoop 19,

A spring washer 20 that is closely fitted, in operative position, by its lower flat butt-end to the upper flat butt-end of above-mentioned head of the mushroom body 18 and by its side face to the inside of said cylindrical hoop 19, and

A replaceable disposable catching shield 21 that made from suitable metallic (usually copper) foil and restrained, in operative position, between lower flat butt-end of above-mentioned head of the mushroom body 18 and above-mentioned circular radial flange of said cylindrical hoop 19.

Above-mentioned International Application PCT/UA03/00015 includes an advice that the shield 21 must have diameter no less than 5dₘₐₓ, and must be placing away the operative butt-end of the anode-enhancer 16 at distance no more than 20dₘₐₓ, where dₘₐₓ is the maximum cross dimension of said anode-enhancer 16. This advice is true in relation to the present disclosure.

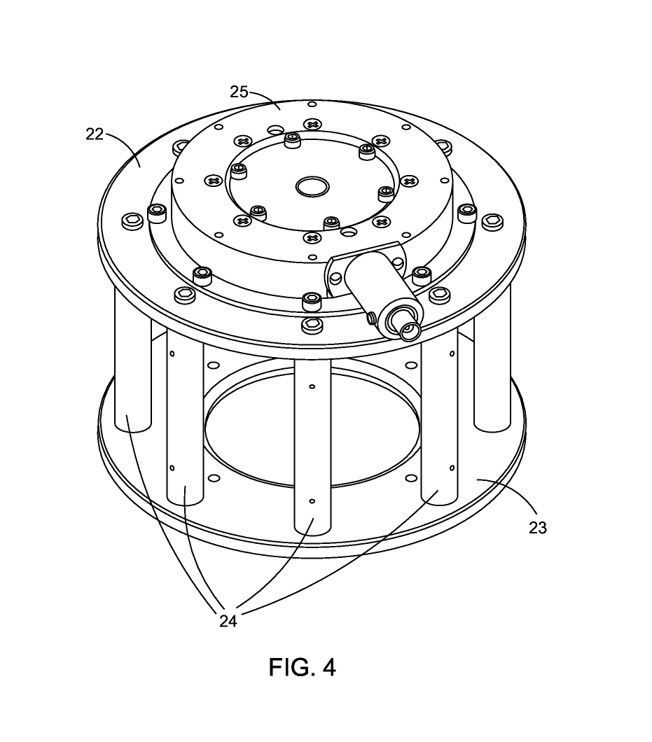

Said short-circuiter 3 of reverse current surrounds concentrically with radial clearance said electrode assembly 2 and has (see FIG. 4) first (arranged opposite the cover 5) and second (arranged opposite the partition 7) parallel flanges 22 and 23 made from a non-ferromagnetic current-conducting material (usually from stainless steel). These flanges 22 and 23 have non-specified especially central openings, geometrical axes both of which are coincident with symmetry axis of said vacuum chamber 1 and are rigidly coupled by at least three spaced with equal angular distances copper buses having identical heights and cross-sections.

First flange 22 may have a proper cover 25 and has connected electrically, in operative position, to the anode-enhancer 16 via said clamper 15.

Second flange 23 has fastened, in operative position, to the partition 7 of the vacuum chamber 1 and contacts electrically with this partition 7. Above-mentioned central opening at least in the first flange 22 must have such diameter, which is sufficient for the purpose of free bringing in and removal of the electrode assembly 2.

A pulsed high-voltage generator (PHVG) for power supply of the RVD is a system that is well-known for any person skilled in the art (see, for example: 1. P. F. Ottinger, J. Appl. Phys., 56, No. 3, 1984; 2. [symbol] [symbol] — [symbol] , 24, No 212, c. 1078, 1984—In English—Dolgachev G. I. et al—Physics of Plasma, 24, No. 12, p. 1078, 1984). Therefore, it has not shown on the drawings. This system comprises connected in series

An input transformer equipped with a means for connection to an industrial network and a high-voltage output winding,

A storage LC-circuit comprising accessible capacitors and inductors, and

An unit for plasma interruption of discharge current in the LC-circuit composed of a set of well known to each person skilled in the art plasma guns symmetrically located in one plane, the number of which (up to 12, in particular) usually being equal to the number of capacitors in the LC-circuit.

Besides of previously mentioned power units, the PHVG incorporates well-known means for measuring pulse current and voltage, such as at least one Rogovski belt and at least one capacitive voltage divider.

For purpose of shock compression of a substance to a superdense state using the described RVD, following steps must be realized

(1) Cutting a stem made from selected solid substance (particularly, in the form of a wire having diameter in the range from 0.5 to 1.0 mm) into a set of such cut-to-length sections, each of which must have length sufficient for reliable fastening in the clamper 15 and further must serve as an anode-enhancer 16;

(2) Formation (for instance, by rounding off) of a spheroidal target on one end of each anode-enhancer 16;

(3) Optionally, installation of the above-described catcher 17 of transmutation products, in which disposable catching shield 21 has beforehand inserted, on the anode-enhancer 16;

(4) Installation of a selected dielectric end element 14 on the central current-conducting rod 13 of above-mentioned plasma cathode;

If a set of single-type experiments must perform, the step (4) performs only at initiation of such set or at revelation of an inadmissible wear of the dielectric end element 14.

(5) Fixation of the mounted plasma cathode in the clamper 12;

(6) Placement of the anode-enhancer 16 (optionally together with said catcher 17) into the clamper 15;

(7) Screwdriving of the clamper 15 together with the anode-enhancer 16 into above-mentioned opening of first dielectric plate 9 of the electrode assembly 2;

At carrying out the step (7), an interelectrode gap must adjust in good time in order to provide hit of the center of curvature of a spheroidal target of the anode-enhancer 16 into a focal space of the collectively self-focusing electron beam during a pulse discharge of a PHVG via RVD.

For example, under condition that typical average energy of electron beam is approximately 0.5 MeV, the dielectric end elements 14 of the plasma cathode having identical lengths 8.75 mm and outer diameter in the range from 16.0 to 24.0 mm, and the anode-enhancers 16, in which radius of curvature and cross-section area of the spheroidal targets were respectively about 0.45 mm and 2.4 mm², were used in the most part of experiments. Accordingly, an interelectrode gap had adjusted in the range from 3.0 to 6.0 mm Then a focal space had revealed in the range from 0.10 to 0.14 mm³

(8) Installation of the mounted electrode assembly 2 within the vacuum chamber 1 and connecting the clamper 12 of the plasma cathode to the PHVG and the clamper 15 of the anode-enhancer 16 to the short-circuiter 3 of reverse current in the earthed circuit;

(9) Closing the vacuum chamber 1 by placing the demountable hatch 6 onto the cover 5;

(10) Vacuumizing the said chamber 1 that performs preferably twice (i.e. including initial pumpdown of air, blow-off the chamber 1 by pure dry nitrogen and repeat pumpdown of gases until residual pressure no more than 0.1 pascal);

(11) Connecting the PHVG to an industrial network via said input transformer and accumulation of a necessary electrical charge in the storage LC-circuit;

(12) Discharge of the storage LC-circuit via above-mentioned unit for plasma interruption of discharge current, said non-consumable central current-conducting rod 13 and the dielectric end element 14 on the RVD anode-enhancer 16 with generation of an electron beam having the electron energy no less than 0.2 MeV, current density no less than 10⁶ A/cm² (but preferably up to 10⁷ A/cm²) and width less than 30 ns;

(13) Smooth equalization of pressure in the vacuum chamber 1 with atmosphere;

(14) Opening of the vacuum chamber 1 by removal of the demountable hatch 6 from the cover 5;

(15) Removal the used electrode assembly 2 from the vacuum chamber 1;

(16) Extraction of transmutation products obtained during the compression of at least a part of the target substance to a superdense state for their following study by conventional methods and aids.

This final step can substantially simplify using the catcher 17. It takes off the anode-enhancer 16, and then the spring washer 20 squeezes, the cylindrical hoop 19 moves along above-mentioned round head of the mushroom body 18 and the catching shield 21 carefully extracts from a gap between said head and the circular radial flange of the cylindrical hoop 19.

### INDUSTRIAL APPLICABILITY

Any proposed RVD for shock compression of a substance may produce from accessible on world market materials and utilities. Any such RVD can use for laboratory studies of shock compression of any solid substance to a superdense state.

What is claimed is:

1. A relativistic vacuum diode for shock compression of a substance to a superdense state, comprising:
an axisymmetric vacuum chamber; this chamber is made from a current-conducting material and confined by a cylindrical shell ring that is equipped with one butt flange, a removable cover that fixed onto said flange and equipped in proper midportion with a demountable hatch for access into the said chamber cavity, and a partition that has at least one through-hole and separates, in operative position, said cavity from a located next buffer cavity communicating with a vacuum line;
an axisymmetric electrode assembly that fixed in operative position in the central zone of said vacuum chamber and comprises
first and second parallel dielectric plates having central openings, geometrical axes both of which are coincident with symmetry axis of said vacuum chamber, at that first dielectric plate located opposite said removable cover and second dielectric plate located opposite said partition of this chamber;
at least two oppositely located dielectric uprights, which rigidly couple said dielectric plates;
a plasma cathode, composed of a central current-conducting rod connecting, in operative position, to a pulsed high-voltage generator and a dielectric end element that gotten coaxially onto said central rod, at that area of operative butt-end of said dielectric element exceeds cross-section area of said central rod;
a clamper of the plasma cathode that fixed in said central opening of said second dielectric plate and has a termination point for connection of this cathode, in operative position, to a pulsed high-voltage generator;
an anode-enhancer in the form of a rod of solid material, one butt-end of which shaped as spheroid and serves, in operative position, as a target for an electron beam, at that maximal cross-section area of this anode-enhancer is less than emitting area of said dielectric end element of the plasma cathode;
a clamper of the anode-enhancer that inserted into said central opening of said first dielectric plate and has a termination point for connection of this anode-enhancer, in operative position, to an earthed circuit;
a short-circuiter of reverse current that surrounds concentrically with radial clearance said electrode assembly and has first and second flanges made from a non-ferromagnetic current-conducting material; these flanges rigidly coupled by at least three spaced with equal angular distances copper buses having identical heights and cross-sections, at that said first flange in operative position connected electrically with said anode-enhancer via its clamper, and second flange connected mechanically and electrically, in operative position, with the partition of said vacuum chamber.

2. The relativistic vacuum diode according to claim 1, wherein vacuum chamber is equipped with at least one viewing window.

3. The relativistic vacuum diode according to claim 1, wherein the anode-enhancer is equipped with a catcher of transmutation products that placed next the said target; this catcher comprises
a mushroom body having a flat and round in plan view head and a hollow stem that clings close to a tail part of the anode-enhancer in operative position;
a cylindrical hoop, which envelopes said head of the mushroom body using sliding fit and which has a circular radial flange directed at geometrical axis of this hoop,
a spring washer that is closely fitted in operative position by its lower flat butt-end to the upper flat butt-end of said head of the mushroom body and by its side face to the inside of said cylindrical hoop, and
a replaceable disposable catching shield that made from metallic foil and restrained in operative position between lower flat butt-end of said head of the mushroom body and said circular radial flange of said cylindrical hoop.

4. The relativistic vacuum diode according to claim 1, wherein said dielectric plates and said dielectric uprights of said electrode assembly made from rigid polymeric material selected from group consisting of polycaproamide, polycarbonate and polypropylene.

5. The relativistic vacuum diode according to claim 1, wherein said dielectric uprights of the electrode assembly have round cross-section and transversely undulating surface.

6. The relativistic vacuum diode according to claim 1, wherein said dielectric end element of the plasma cathode has a central through-hole, at that its diameter is less than diameter of said central current-conducting rod of this cathode.

7. The relativistic vacuum diode according to claim 1, wherein said flanges of the short-circuiter of reverse current made from stainless steel.
